(19) United States
(12) Patent Application Publication
(10) Pub. No.: US 2013/0092856 A1
(43) Pub. Date: Apr. 18, 2013

(54) FLUID CONTROL VALVE, IN PARTICULAR A SEAT VALVE

(71) Applicant: Friedrich Schuler, Wilhelmsdorf (DE)

(72) Inventor: Friedrich Schuler, Wilhelmsdorf (DE)

(73) Assignee: SCHAEFFLER TECHNOLOGIES AG & CO. KG, Herzogenaurach (DE)

(21) Appl. No.: 13/805,395

(22) PCT Filed: Jun. 15, 2011
(86) PCT No.: PCT/EP2011/059897

§ 371 Date: Dec. 19, 2012

(30) Foreign Application Priority Data
Jun. 28, 2010 (DE) 10 2010 025 370.7

(51) Int. Cl. F16K 27/02; F16K 31/06

(52) U.S. Cl. CPC F16K 27/0245; F16K 31/0665
USPC 251/129.15; 251/359

(57) ABSTRACT

A fluid control valve, which is in particular a seat valve (2), including a valve housing (4) in which a feed duct (10) having an inlet (6) and a discharge duct (20) having an outlet (8) for pressurized medium are formed, which are fluidically connected to each other. The fluid control valve additionally includes a closing element (16a, 16b, 16c) which is arranged in the valve housing (4), that can be moved in an axial direction (A) between an open position and a closed position and, in the closed position, interrupts the fluidic connection between the feed duct (10) and the discharge duct (20). Radial feeding of the pressurized medium is ensured in that the feed duct (10) extends substantially in a radial direction (R) and is separated by an inner partition (26) from the discharge duct (20), which surrounds the feed duct (10) and extends substantially in the axial direction (A).

### FIELD OF THE INVENTION

The invention relates to a fluid control valve, in particular a seat valve.

### BACKGROUND

Electromagnetically actuated fluid control valves are used in a wide variety of applications for controlling fluid flows in the automotive field. In its simplest design, a fluid control valve has two fluid ports and two switching positions. Such valves are used for example to enable or shut off a fluid flow for a cooling application, for example for cooling the pistons of an internal combustion engine.

Depending on the configuration of the hydraulic part, a distinction is made between two main designs of fluid control valves: slide valves and seat valves. Furthermore, fluid control valves may be divided, depending on the direction of the pressure medium supply, into valves with a pressure supply “from the side” (radial) and “from the front” (axially).

If the pressure supply or the pressure medium supply to a valve takes place from the side (transversely with respect to an axial direction of the approximately cylindrical valve housing) and the pressure medium is discharged in an axial direction, use is generally made of slide valves. The disadvantages thereof are that narrow fit tolerances are required between the valve housing and a slide, such that valves of this type are relatively expensive and sensitive to dirt. Furthermore, leakage occurs in the gap between the slide and the valve housing.

Another embodiment of a valve is the so-called seat valve. Known seat valves generally exhibit a pressure supply in the axial direction, that is to say in the direction of movement of the closing body, and a discharge of the pressure medium in the radial direction. Seat valves are however less suitable for demanding regulation tasks. Furthermore, the installation possibilities for known seat valves are restricted due to the described flow guidance.

DE 199 33 363 A1 describes a device for cooling the pistons of an internal combustion engine with oil, wherein a valve is provided in a main supply line which leads to a lubricating oil circuit.

DE 10 2005 010 234 A1 discloses a piston cooling arrangement for an internal combustion engine, which piston cooling arrangement has an oil spray nozzle which is connected to an oil distributor duct. The oil distributor duct has a connection to a lubricating oil duct, from which lubricating oil is fed by a control valve, controlled as a function of operating parameters, into the oil distributor duct. Here, the connection between the oil distribution duct and the lubricating oil duct is in the form of a receiving bore for the control valve.

The design of a magnetically actuated fluid control valve emerges for example from DE 10 2007 033 060 A1.

### SUMMARY

The invention is based on the object of permitting a simple design of a fluid control valve for a radial supply of the pressure medium.

The object is achieved according to the invention by means of a fluid control valve, in particular seat valve, comprising a valve housing in which there are formed a supply duct with an inlet and a discharge duct with at least one outlet for a pressure medium, said supply duct and discharge duct being connected to one another in terms of flow, and also comprising a closing body which is adjustable in an axial direction between an open position and a closed position and which, in the closed position, blocks the flow connection between the supply duct and the discharge duct, wherein the supply duct extends substantially in a radial direction and is separated from the discharge duct by an inner partition, said discharge duct surrounding the supply duct and extending substantially in the axial direction.

A simple design of the fluid control valve, in which in particular a restoring spring is dispensed with, is ensured by means of the special arrangement of the supply duct and of the discharge duct with respect to one another. By means of the substantially radially extending supply duct, the pressure medium, for example oil, is supplied radially into the valve housing. The change in direction of the pressure medium takes place approximately centrally in the valve housing, and said pressure medium is discharged in the axial direction via the discharge duct. Here, the supply duct extends in the radial direction as far as approximately the center of the valve housing. The end of the supply duct is delimited, in the valve housing, by the partition. In said region, the valve housing is in the form of a double-walled housing. Also alternatively possible is a single-walled design of the valve housing in which the inner partition is provided and a surrounding outer wall of the valve housing is dispensed with, and the valve is instead delimited radially by the wall of an installation bore in which the valve is arranged during operation. As viewed in the flow direction, the discharge duct runs, behind the partition, adjacent to the transition region. The discharge duct is formed in one or more parts, extends substantially axially, and opens at the front into the outlet. Here, the discharge duct surrounds the supply duct in particular in the shape of a circular arc. Therefore, during operation of the valve, there are in the region of the partition two pressure medium flows which flow in different directions: the radially flowing flow in the supply duct to the partition, and behind the partition, the axially flowing flow in the discharge duct.

A valve seat for the closing body is preferably arranged axially above the supply duct. With regard to diversion of the pressure medium which is particularly expedient in terms of flow, the valve seat for the closing body is arranged not at the level of the supply duct but rather is positioned axially above the supply line or the inlet. Here, the change in direction of the pressure medium from the radial direction to the axial direction takes place above the supply duct at the point where the valve seat is situated. The advantage here is that the pressure of the pressure medium can be utilized to raise the closing body axially from the valve seat, and thus move this closing body into the open position and hold it there.

Within the valve housing, the pressure medium flows through a total of three regions. The pressure medium is introduced radially from the side of the valve housing into the supply duct, wherein the radial supply duct extends to below the valve seat. There follows a transition region in which the valve seat is arranged.

In the transition region, the pressure medium changes its flow direction firstly to axially “upward”, in order to raise the closing body, until the pressure medium reaches the axially extending discharge duct and flows axially “downward” in said third region. The partition extends from the base of the supply duct axially upward to the region of the valve seat. Here, the height of the partition above the feed duct defines that part of the transition region in which the pressure medium flows axially upward.

In a preferred embodiment, a plunger rod interacts with an electromagnet in such a way that, when the electromagnet is energized, the plunger rod holds the closing body in the closed position. Even in the event of faults in the operation of the electromagnet, it is thus ensured that for example a cooling function by means of the pressure medium continues to be provided, because in the deenergized state of the electromagnet, the closing body is raised into the open position by the pressure force of the pressure medium, and the pressure medium can flow through the valve.

With regard to particularly simple assembly and guidance of the closing body, according to a further preferred embodiment, said closing body is formed in one piece with the plunger rod. Here, the closing body and the plunger rod have been manufactured in the same manufacturing step from the same material, in particular from plastic. Alternatively, the closing body and the plunger rod are two separate components which have been joined together, thus forming a unit, before being inserted in the valve. Here, the closing body may be composed of a hard, wear-resistant material.

In the valve housing there are preferably provided a number of ribs for the guidance of the closing body. In particular, at least three ribs are provided which are each equidistant from one another. The ribs project radially inward and are dimensioned such that the closing body is guided by the ribs. The ribs extend from the valve seat axially upward (that is to say in the opposite direction to the discharge duct) over a length which is adapted to the axial movement path of the closing body during the opening and closing of the valve. The ribs furthermore serve for stiffening the valve housing.

The valve housing is preferably manufactured by casting. The valve housing is for example produced from plastic in an injection molding process or from metal in a pressure die casting process. Plastic is characterized by weight advantages, and is furthermore particularly well suited to the filigree form of the double-walled valve housing. It is alternatively also possible for the valve housing to be produced from metal, which is particularly advantageous in the case of high operating pressures. In this case, a manufacturing process using aluminum or zinc die casting is in particular suitable for forming the housing.

The closing body is expediently in the form of a ball, a ball segment, a cone or a truncated cone. The ball is formed in particular from a metal, such as for example steel, and is in particular a component separate from the plunger rod. Balls are inexpensive and are available with high hardnesses and good precision. Alternatively, the closing body has, on the side directed toward the valve seat, the form of a ball segment, a cone or a truncated cone.

In the presence of relatively large fluid flows, a valve with a ball as a closing body can become unstable, because the flow attaches to the ball and fluctuating forces in the direction of the valve seat are generated, which causes the ball to oscillate. By means of a special profiling of the closing body, the flow of the pressure medium when the valve is open can be influenced. To prevent the flow from attaching to the closing body, said closing body advantageously has an encircling separation edge. For example, in the case of a closing body in the form of a spherical segment, the separation edge is formed in the outer region around the circumference of the ball segment.

It is furthermore advantageous that the separation edge is preferably in the form of a collar which has a profiling opposed to a convex surface of the closing body. If the closing body is in the form of a ball, a ball segment, a cone or a truncated cone, it always has a convex surface directed toward the valve seat. Correspondingly, the collar which in particular encircles the convex surface has a concave form.

As a result of the angle and length of the collar, the lift force on the closing body is influenced in a targeted manner and optimized for the respective application.

The closing body preferably has an axially extending guide cylinder which adjoins the separation edge. The guide cylinder extends from the separation edge axially upward, and forms a type of sleeve around the plunger rod. By means of the guide cylinder, the closing body is guided particularly reliably along the ribs, and tilting of the closing body is prevented.

### BRIEF DESCRIPTION OF THE DRAWING

Exemplary embodiments of the invention will be explained in more detail on the basis of a drawing, in which:

FIG. 1 shows a side view of a magnet valve,

FIG. 2 shows a section through the plane A-A as per FIG. 1,

FIG. 3 shows a cross section through the plane B-B as per FIG. 1,

FIG. 4 shows a cross section through the plane C-C as per FIG. 1,

FIG. 5 shows a longitudinal section through a second design variant of a magnet valve,

FIG. 6 shows an enlarged view of a closing body as per FIG. 5, and

FIG. 7 shows a third design variant of a magnet valve.

### DETAILED DESCRIPTION OF THE PREFERRED EMBODIMENTS

Parts having the same function are denoted by the same reference symbols in the figures.

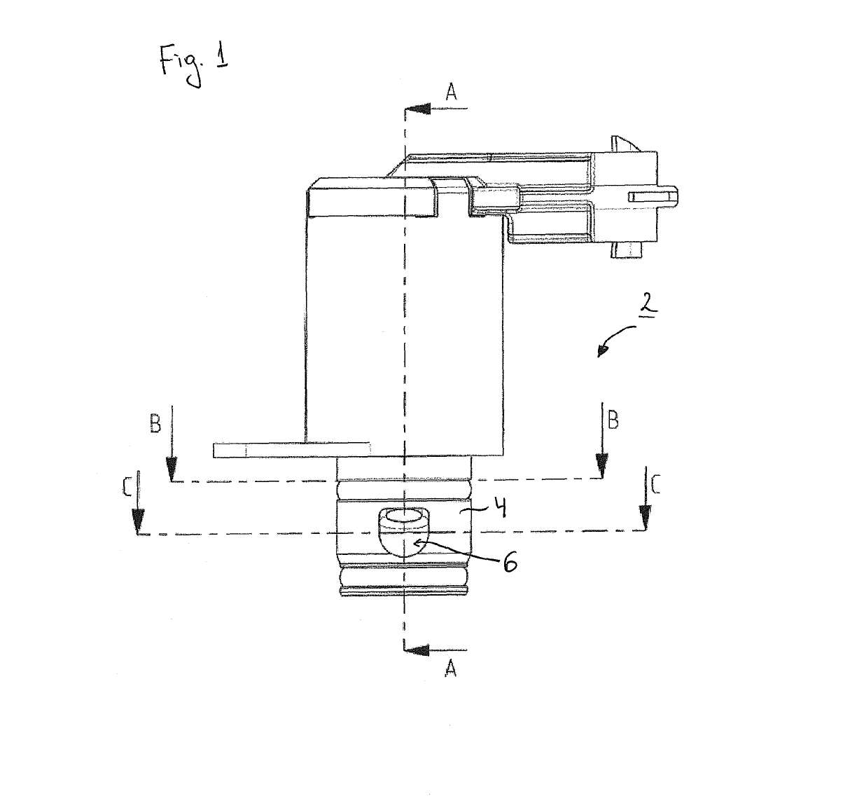

FIGS. 1 to 4 show a first design variant of a fluid control valve which is situated in an installation bore (not shown in any more detail here) of a machine element. In this exemplary embodiment, the fluid control valve is in the form of a seat valve 2 and will be referred to hereinafter as seat valve for simplicity.

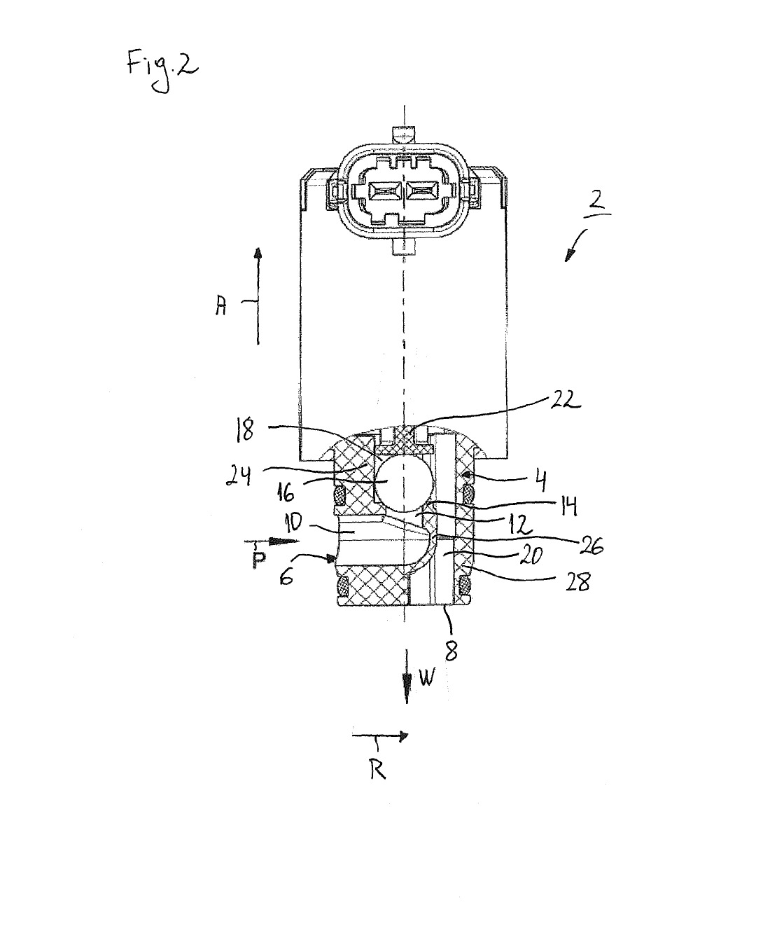

The seat valve 2 has a valve housing 4 in which there are formed an inlet 6 and an outlet 8 for a pressure medium, such as for example oil. The inlet 6 on the pressure side is arranged for a supply of the oil in a radial direction R, as indicated in FIG. 2 by the arrow P. In the housing 4, the oil flows firstly in the radial direction R along a supply duct 10 until it reaches a transition region 12, in which there is arranged a valve seat 14 for a spherical closing body 16a. Here, the valve seat 14 is situated, as viewed in the axial direction A, above the inlet 6 and thus also above the supply duct 10. In FIG. 2, the valve 2 is illustrated in a closed position in which the closing body 16a is seated on the valve seat 14. During operation of the valve 2, the closing body 16a is raised by the pressure of the oil, and in the open position of the valve 2, floats in a receiving chamber 18 above the valve seat 14. Finally, the oil passes into an axial discharge duct 20 which opens into the outlet 8. The axial discharge of the oil is indicated in FIG. 2 by the arrow W.

In the exemplary embodiment shown, the closing body 16a is a ball comprised of steel. A plunger rod 22 is moved by an electromagnet (not shown in any more detail here) and presses against the ball 16a. The plunger rod 22 is coupled to the electromagnet in such a way that, when the electromagnet is energized, the plunger rod 22 pushes the ball 16a downward into the valve seat 14. When the electromagnet is in the deenergized state, the pressure medium must, depending on the installation position, overcome the weight and friction force of the moving parts of the valve 2 in order to open the valve 2.

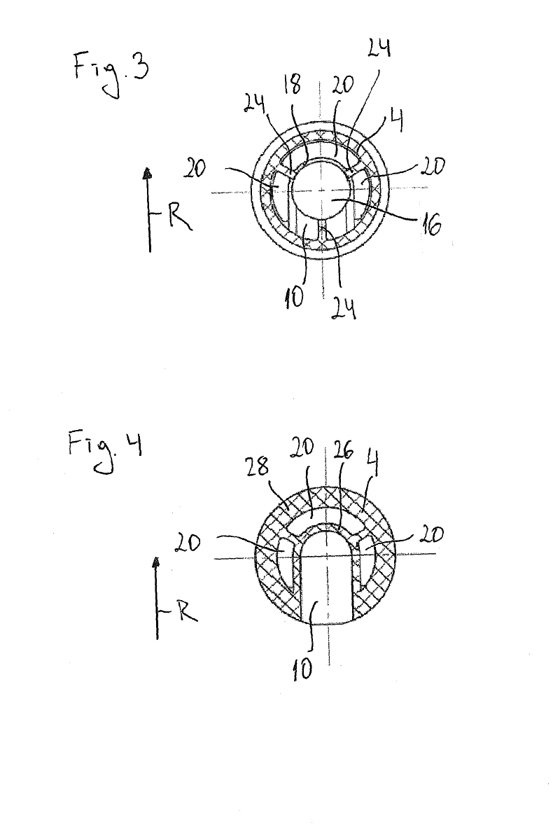

In the exemplary embodiment shown, the valve housing 4 is formed from plastic. For stiffening of the housing 4 and for the guidance of the ball 16a, three ribs 24 are provided in the receiving region 18, which ribs can be seen in FIG. 3. The ribs 24 extend axially along the entire receiving chamber 18. These ribs permit an axial movement of the ball 16a and prevent a displacement of the movement path of the ball in the radial direction R.

Between the discharge duct 20 and the supply duct 10 there is provided a partition 26. The valve housing 4 is thus of double-walled design and has a cylindrical outer housing wall 28 and the inner partition 26, wherein the inner partition 26 runs substantially concentrically with respect to the outer housing wall 28 and is radially open in the region of the supply duct 10. As can be seen from the cross section of the valve housing 4 in FIG. 4, the discharge duct 20 comprises a plurality of ring segments.

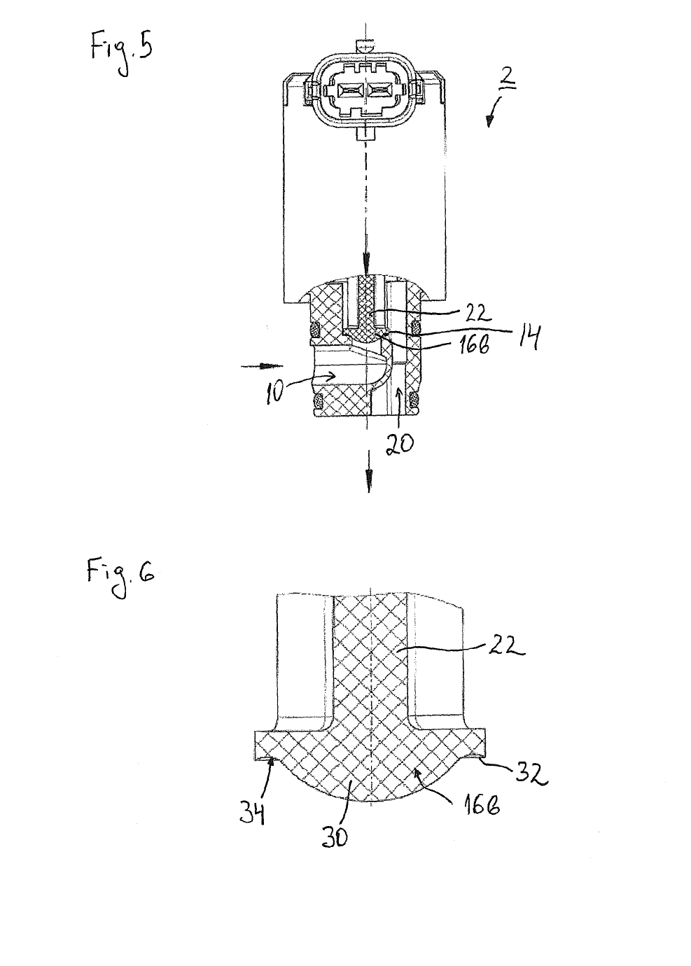

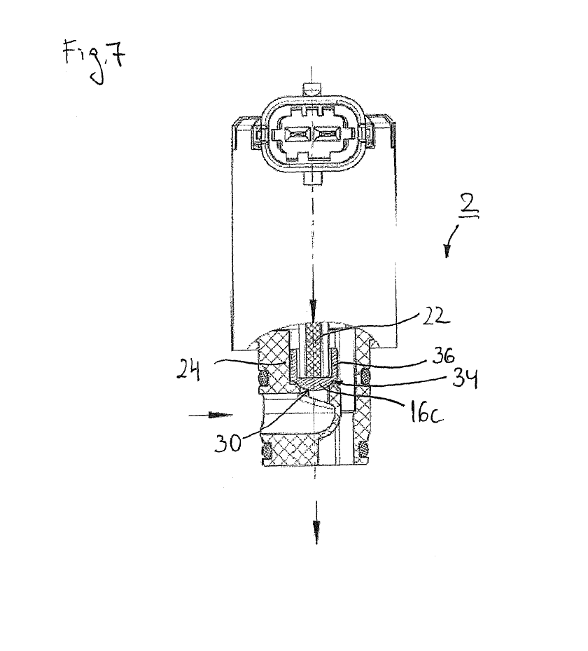

FIG. 5 shows a second design variant of a valve 2. This design variant differs from the first design of the valve 2 merely by the closing body 16b. In the second exemplary embodiment, the closing body 16b, the detailed design of which can be seen in FIG. 6, is a ball segment 30 which is formed in one piece with the plunger rod 22 and which is comprised of the same material as the plunger rod 22, that is to say from plastic. The plunger rod 22 and the closing body 16b form a pre-manufactured unit and are non-separable.

The flow behavior of the oil can be influenced by the geometry of the closing body 16b. For hydrodynamic reasons, an encircling separation edge 32 is therefore formed around the circumference of the ball segment 30. The separation edge 32 prevents the flow from following the further profile of the closing body 16b and thus undesired hydrodynamic forces being generated which make the valve 2 unstable. An encircling collar 34 in the region of the separation edge 32 has a profile which is opposed to the convex ball segment 30, that is to say the collar 34 is formed as a concave curvature. Here, the angle at which the flow impinges on the separation edge 32 determines the flow characteristics, which can be adapted to the application by means of a suitably selected angle.

FIG. 7 shows a third design variant of a valve 2, which differs from the two variants described above by its pot-shaped closing body 16c. Here, the closing body 16c is likewise formed as a ball segment 30 on its underside. The closing body 16c and the plunger rod 22 are however two separate components. The plunger rod 22 is for example comprised of plastic, and the closing body 16c is metallic, for example comprised of steel. With regard to improved guidance of the closing body 16c, the latter is enhanced to include an axially upwardly extending guide cylinder 36 which slides along the ribs 24 during the raising and lowering of the closing body 16c.

In principle, the different geometries of the separation edge 32 in FIG. 5 and FIG. 7 are interchangeable. If the closing body in FIG. 7 is formed from a hard material, small bevels or roundings are required at the top and bottom ends of the cylindrical guide cylinder 36 in order to avoid damage to the guide ribs 24.

### LIST OF REFERENCE SYMBOLS

2 Seat valve
4 Valve housing
6 Inlet
8 Outlet
10 Supply duct
12 Transition region
14 Valve seat
16a,b,c Closing body
18 Receiving chamber
20 Discharge duct
22 Plunger rod
24 Rib
26 Partition
28 Housing wall
30 Ball segment
32 Separation edge
34 Collar
36 Guide cylinder
A Axial direction
P Arrow
R Radial direction
W Arrow

1. A fluid control valve, comprising a valve housing in which there are formed a supply duct with an inlet and a discharge duct with at least one outlet for a pressure medium, said supply duct and said discharge duct being connected to one another by a flow connection, a closing body arranged in the valve housing and which is adjustable in an axial direction (A) between an open position and a closed position and which, in the closed position, blocks the flow connection between the supply duct and the discharge duct, wherein the supply duct extends substantially in a radial direction (R) and is separated from the discharge duct by an inner partition, said discharge duct surrounds the supply duct and extends substantially in an axial direction (A).

2. The fluid control valve as claimed in claim 1, wherein a valve seat for the closing body is arranged axially above the supply duct.

3. The fluid control valve as claimed in claim 1, wherein a plunger rod interacts with an electromagnet in such a way that, when the electromagnet is energized, the plunger rod holds the closing body in the closed position.

4. The fluid control valve as claimed in claim 3, wherein the closing body is formed in one piece with the plunger rod.

5. The fluid control valve as claimed in claim 1, wherein in the valve housing there are provided a number of ribs for guidance of the closing body.

6. The fluid control valve as claimed in claim 1, wherein the valve housing is a cast part.

7. The fluid control valve as claimed in claim 1, wherein the closing body is a ball, a ball segment, a cone or a truncated cone.

8. The fluid control valve as claimed in claim 1 wherein the closing body has an encircling separation edge.

9. The fluid control valve as claimed in claim 8, wherein the separation edge is a collar which has a profiling opposed to a convex surface of the closing body.

10. The fluid control valve as claimed in claim 8, wherein the closing body has a guide cylinder which extends axially from the separation edge.
